(19) United States
(12) Patent Application Publication
(10) Pub. No.: US 2016/0060031 A1
(43) Pub. Date: Mar. 3, 2016

(54) DEVICE COMPONENT OF A PNEUMATIC WASTE CONVEYING SYSTEM

(71) Applicant: MARICAP OY, Vantaa (FI)

(72) Inventor: Göran SUNDHOLM, Tuusula (FI)

(73) Assignee: MARICAP OY, Vantaa (FI)

(21) Appl. No.: 14/786,059

(22) PCT Filed: Apr. 8, 2014
(86) PCT No.: PCT/FI2014/050248

§ 371 Date: Oct. 21, 2015

(30) Foreign Application Priority Data
Apr. 22, 2013 (FI) 20135409

(51) Int. Cl. B65F 5/00; B30B 15/04; B65G 53/50; B65G 53/60; B65G 53/36

(52) U.S. Cl. CPC B65F 5/005; B65G 53/60; B65G 53/36; B65G 53/50; B30B 15/04

(57) ABSTRACT

Device component of a pneumatic waste conveying system, which device component includes a frame structure arrangement. A device component, such as a separating device, material container, press device or pump device unit, in the frame structure arrangement is arranged in a supported manner at least partly inside a support body framework, which support body framework is configured to function as a freight transport container. The support body framework is configured to function as a support body for the device component at the installation site.

### FIELD OF THE INVENTION

The invention relates to a device component, as defined in claim 1, of a pneumatic wastes conveying system, which device component comprises a frame structure arrangement.

### BACKGROUND OF THE INVENTION

In pneumatic conveying systems for wastes, especially in high-capacity systems, various device components are used, e.g. separating devices, presses, containers, pumping stations, et cetera, that require a support body when installing the device components at the disposal location. The systems are installed in and delivered to sites that can be situated geographically very far from their place of manufacture. In this case the requirements for the installability of the device components and for the efficient transportability of them to the installation site are of great importance.

Transportation of device components to the installation sites as general cargo is often awkward and expensive. In addition, assembly of the installation frame at the installation site requires an appreciable work input.

On the other hand, known in the art are effective transportation solutions wherein devices are transported to the installation site in so-called standard containers and assembled on-site for installation there. Certain requirements are set for standard containers, e.g. in respect of dimensions, the load-bearing capacity of the containers and the fixing parts arranged on the containers, such as corner castings arranged on the corners of a container. Standard containers are in widespread use, e.g. known in the art are so-called ISO freight containers that are different, inter alia, in their size and intended usage. These types of containers are widely used, inter alia, in maritime transportation and other transportation. Also known in the art are other standardized container systems.

The aim of the present invention is to achieve a solution for a frame structure arrangement for the device components of a pneumatic wastes conveying system, said solution having the property of good mobility to the installation site, and the installability of which solution at the installation site is good.

### BRIEF DESCRIPTION OF THE INVENTION

The invention is based on a concept wherein the frame structure arrangement for device components comprises structural elements arranged to the dimensions of so-called standard freight containers. Preferably the frame structure arrangement comprises a support body framework, which is provided with the corner castings for a standard container, and the structures of the body framework of which arrangement are configured to be according to the requirements set for transportation, storage and stacking and according to the minimum requirements required of the body framework at the installation site.

The device component, according to the invention, of a pneumatic wastes conveying system is mainly characterized by what is stated in the characterization part of claim 1.

The device component according to the invention is also characterized by what is stated in claims 2-11.

The solution according to the invention has a number of important advantages. By forming the support body of the device components of a pneumatic waste handling system to correspond to the dimensions and, possibly, also other essential requirements of a freight container, an effective solution for the transportation of device components is achieved. In addition, when the support body is configured to function at the installation site as a support body for the device component, the installation phase of the devices of a waste conveying system at the installation site can be made significantly more efficient. By using a support body framework in which the device components have been arranged, e.g. with bracing parts, in a supported manner, an effective and robust structure for a support body is achieved. According to the invention a device component, which is arranged in a support body frame, can be installed at the installation site in a different attitude than the transport attitude of the device component arranged in the support body frame. By arranging the dimensions of the support body framework to correspond to the dimensions of a so-called standard container, significant savings can be achieved in transport costs compared to a situation in which a device component is transported as general cargo. The device component assembly according to an embodiment of the invention, said assembly comprising a separating device, a press device and a waste container, can be efficiently transported in an efficiently compact form to the installation site, where the support body frames of the device components function as installation frames for the device components.

### BRIEF DESCRIPTION OF THE FIGURES

In the following, the invention will be described in more detail by the aid of an embodiment with reference to the attached drawings, wherein

FIG. 1 presents an embodiment of the invention at the installation site,

FIG. 2 presents an embodiment of the invention in connection with a device component, in the figure with a separating device,

FIG. 3 presents a detail of one device component, in the figure a press device, to be used in connection with an embodiment of the invention,

FIG. 4 presents an embodiment of the invention in connection with a second device component, in the figure a waste container,

FIG. 5 presents an embodiment of the invention from the direction of the arrow C of FIG. 1,

FIG. 6 presents an embodiment of the invention from the direction of the arrow B of FIG. 1,

FIG. 7 presents device components according to an embodiment of the invention, said device components being in the transport attitude and the second device component being presented with dashed lines.

### DETAILED DESCRIPTION OF THE INVENTION

FIG. 1 presents a separating device 1, a press device 2 and a container device 3 of one pneumatic wastes conveying system, a frame structure arrangement configured to the dimensions and other requirements of a so-called standard container being applied as the body structure framework of which devices.

In the embodiment according to FIG. 1 the device components, such as a separating device and a container, of a wastes conveying apparatus are arranged inside the support body framework 11, 31 of the frame structure arrangement and are fixed to the support body framework 11, 31 with bracing parts 122, 123; 321, 322, 323, 324, 325.

The separating device assembly 1 comprises a container part 10, which in the figure is a so-called cyclone separator, which has a cylindrical section 126 and a truncated conical section 125 and a narrower cylindrical section 124 in which is the material output aperture of the separating device. At the top end of the separating device (in the operating attitude) is a cylindrical section 127, in which is an outlet aperture 128 for the transporting air. In the frame structure arrangement, the separating device is arranged in the support body framework 11 inside the space bounded by its structural elements. According to one embodiment the support body framework 11 is formed from structural elements, which are fitted together according to the dimensioning of a standard container, e.g. according to ISO standards.

In this case in one embodiment, in the transport attitude (separating device in the horizontal position), the length L1 of the framework 11 is e.g. 20 feet (6058 mm). According to one embodiment the width S1 of the support body framework 11 is 8 feet (2438 mm) as per the standard. The height H1 (in the transport attitude) of the support body framework 11 can be according to the standard or the dimension of it can be higher or lower, e.g. in the embodiment of the figures the height of the support body framework 11 of the separating device 1 is to some extent larger, approx. 10 feet (2896 mm). The dimensions mentioned are given by way of example and they can differ according to the application. The outer dimensions of ISO standard containers vary e.g. according to the nominal length. For example, freight containers having a nominal length of 10, 20, 40 and 40 feet are known, the width of which containers is 8 feet. The nominal height can vary, e.g. 8 feet, 8.5 feet, but also known are higher than normal containers (not ISO containers) having a greater height e.g. 9.5 feet.

The separating device 10 is fixed to the support body 11 with bracing parts 122, 123. The bracing parts 122, 123 are fixed, e.g. by welding or with a mechanical joint, to the support body 11. The bracing parts 122, 123 in the embodiment of the figure are plate parts, but they can be parts of some other type, such as profile parts or pipe parts.

According to one embodiment, support part profiles 119, 120 for lifting, e.g. for the fork of a forklift truck, are arranged on the support body framework 11. In this case the fork of the forklift truck is placed in the channel space 119, 120 of the support part profile, i.e. in the so-called forklift pocket, for lifting, in which case the support surface of the fork rests when lifting on the inside surface of the channel space. On the corners of the support body framework 11 are the corner castings 115, 116, 117, 118, 115′, 116′, 117′, 118′ required of standard containers, in which castings the necessary fixing points, such as apertures, are formed, for lifting containers or fixing containers e.g. with fixing means (not presented) to each other or to a means of transport. The properties of corner castings and the fixing between structural elements and corner castings are not described in more detail here, but instead their properties are configured to conform to a standard used for standard containers.

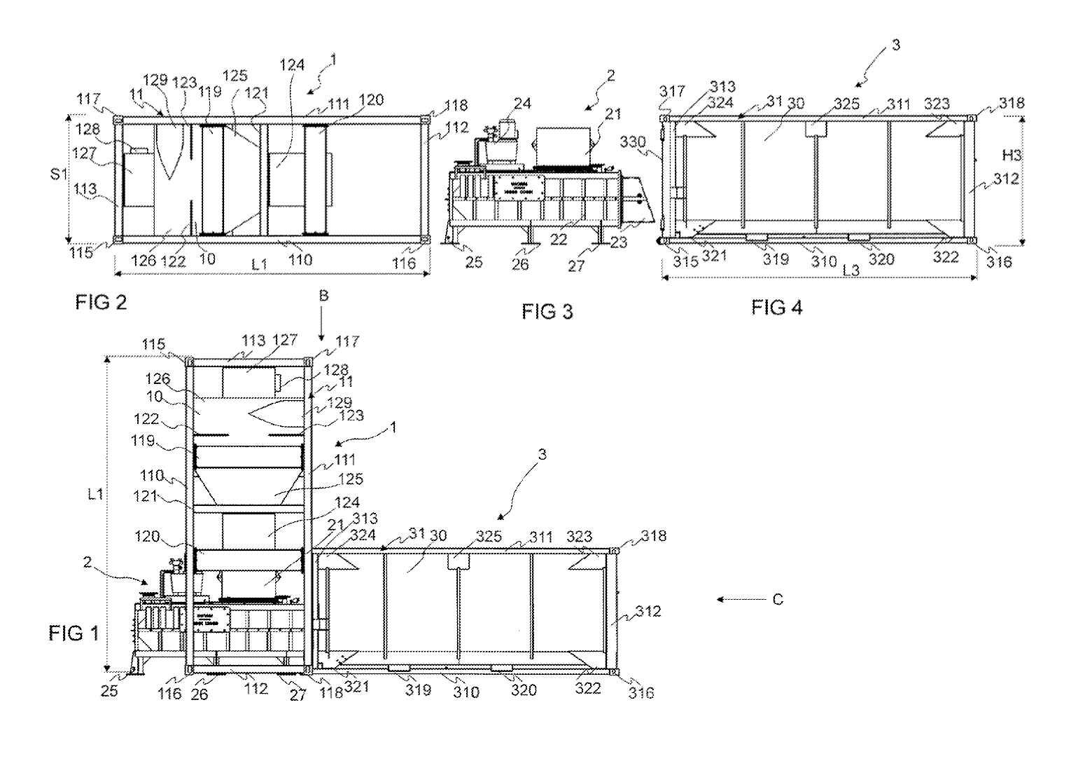

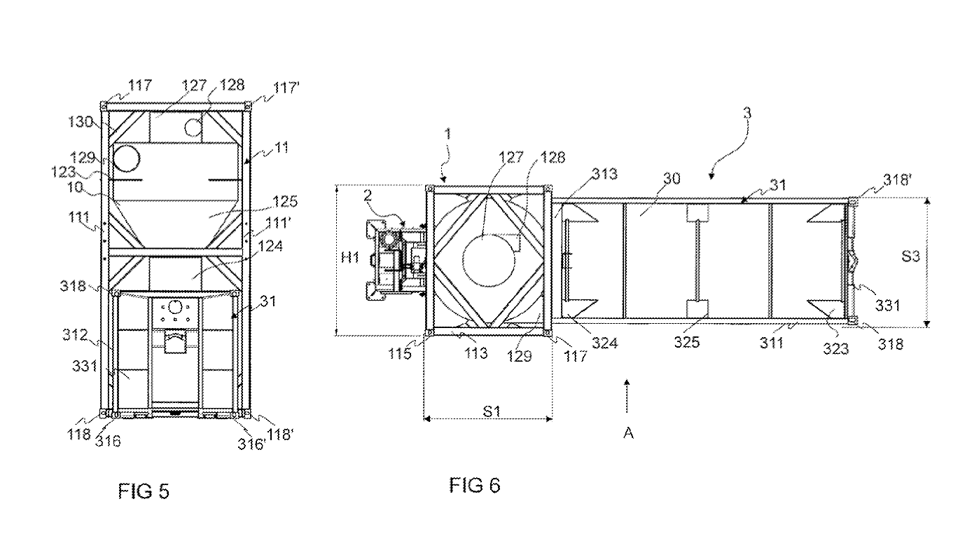

The support body framework 11 in FIGS. 1, 2, 5 and 6 is formed from at least the following structural elements: longitudinal beam 110, longitudinal beam 111, lateral beam 112, lateral beam 113, longitudinal beam 110′, longitudinal beam 111′, lateral beam 112′, lateral beam 113′, which are connected to corner castings 115, 116, 117, 118, 115′, 116′, 117′, 118′ in such a way that an essentially rectangular support body framework 11 forms.

In the embodiments of FIGS. 1, 2, 4 and 5, support pieces 121, 130 are arranged on the support body framework 11 for ensuring the strength of the framework in the embodiment of the invention. In FIG. 5 there are also diagonal support parts. The number and placement of the support parts depend, inter alia, on the type of device component and on the application site. To cover the apertures of the sides of an open support body framework 11, some walls or a tarpaulin can be arranged as top walls, bottom walls side walls and/or end walls e.g. during transportation. One or more of the walls of the support body framework can be formed to be closed. For example, the bottom wall can be formed into a floor.

In FIGS. 1, 4, 5, 6 the second device unit of the frame structure arrangement is a waste container assembly 3, which comprises a container part 30, which is formed inside its own support body framework 31 and fixed with bracing parts 321, 322, 323, 324, 325 to the support body framework 31. The support body framework 31 of the waste container in the figures comprises parts configured to the dimensions of a standard container of standard dimensions, e.g. a so-called 20-foot freight container. The length L3 (both in the transport attitude and in the installation attitude) of the support body framework of the waste container assembly 3 is in one embodiment approx. 20 feet (6058 mm), the width S3 is approx. 8 feet (2438 mm) and height H3 is approx. 8 feet (2438 mm). Walls 330, 331 are formed on the ends of the support body framework 31, said walls comprising the components needed in operating the waste container, such as connections, valves, and openable and closable hatches. In one embodiment one or both end walls 330, 331 are formed to be openable and closable hatches. From the hatches a pathway opens from the end of the container part 30 into the container space. The container part 30 extends in the embodiment of the figures from the first wall 330 to the second wall 331. The container part 3 in the embodiment of the figure is mainly cylindrical, but it can also be a container of some other shape fixed with bracing parts to the support body framework 31. Lifting points 319, 320, e.g. for the lifting means of a fork of a forklift truck, are arranged on the support body framework 31, in its bottom part, of the waste container. The lifting points 319, 320 are, with respect to the longitudinal direction L3 of the waste container, arranged in the transverse horizontal direction and preferably extend from the first side of the container assembly to the second side.

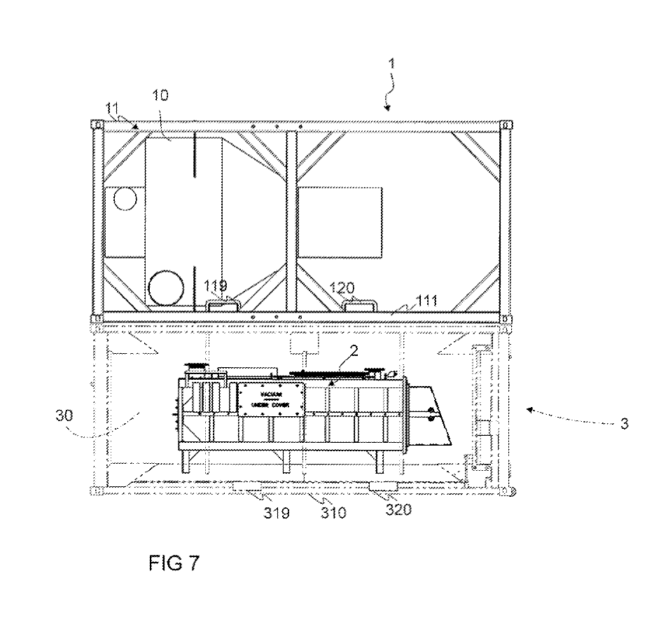

The press device 2 in the assembly presented in the figures of the drawings, which press device is presented on its own in FIG. 3, can be arranged during transportation e.g. in the container space of the container part 30 of the waste container 3. In this case the assembly comprising the separating device, the press and the waste container of the pneumatic wastes conveying system of the figures can be transported as a compact entity, as transport units conforming to the standards, to the installation site. This is presented in FIG. 7.

At the installation site the separating device assembly 1 with its support body framework 11 is arranged into a vertical attitude (as in FIG. 1), in which case the output channel 124 points downwards. The press device 2 is arranged under the output channel 124 of the separating device in such a way that the input aperture of the press device can be arranged, by means of an adapter part 21, into medium connection with the output aperture of the output channel 124 of the separating device 1.

The waste container 3 can be detachably connected against the output aperture 23 of the press device 2 in the operating attitude. The support body framework 31 of the waste container 3 is, when installed, arranged against the bottom part of the upright support body framework 11 of the separating device 1.

The separating device 1 comprises a container part 10, to which an inlet pipe 129 is connected, which inlet pipe is connected to the conveying piping (not presented) for wastes and which can be connected to input points (not presented). Material, such as household waste, is fed in an input point into the piping, where it is conveyed by the aid of suction/a pressure difference and/or transporting air flowing in the piping into the container part 10 of the separating device from the inlet pipe 129, in which container part 10 of the separating device the waste material is separated from the transporting air, e.g. by the aid of gravity and/or centrifugal force, such that heavier material finds its way to the bottom part of the separating device. An outlet pipe 128 for the transporting air is arranged in the top part of the separating device, which outlet pipe is connected to the suction side of a partial-vacuum generator, such as of an ejector pump or fan. The transporting air leaves the container part 10 of the separating device into the outlet pipe.

The storage part 10 of the separating device 1 comprises, in the embodiment of the figure, a section 125 tapering conically towards the bottom part. In the embodiment of FIG. 1 a cylindrical section 124, having an output aperture for material in its bottom part, is arranged in the bottom part of the container part 10 of the separating device after the conical section. Material can thus leave the container part 10 via the output aperture formed in its bottom part.

A press device 2 is arranged in connection with the separating device 1 between the material output aperture of the container part 10 of the separating device and the separate waste container 3, the input aperture of which press device is arranged face-to-face with the output aperture of the container part of the separating device. The output aperture 23 of the press device can be arranged face-to-face with the input aperture of the separate waste container 3, said input aperture being formed in wall 330 of the waste container. The input aperture of the press device 2 is connected to the bottom part of the container part of the separating device with an adapter part 21.

The press device comprises a transfer member that is movable between at least two positions. The transfer member is arranged to transfer waste material, which is conducted from the input aperture into the press device, towards its output aperture and onwards into a separate waste container 3 from the input aperture, or at least into the proximity of the input aperture. The transfer member can, in connection with the transfer, simultaneously also compress the waste to be conveyed to be denser, i.e. to compact the waste into the separate waste container 3.

The figure presents a press device 2 and a separate waste container 3, such as a freight container for waste, which freight container can be coupled into connection with said press device. The figure presents a neck surrounding an input aperture on the top of the press device 2. In the figure, the press device 2 and the waste container 3 are arranged on a mounting surface, such as on a floor surface. The press device 2 is typically coupled into connection with a separating device 1 of a pneumatic pipe transport system for wastes, from where the waste material is fed into the press 2 from the input aperture of it.

The press device 2 comprises an output aperture 23, from which the waste material is transferred into the waste container 3 from the input aperture of the waste container, which input aperture is formed in the wall 330. When a waste container is coupled into connection with the press device, the waste container 3 and the press device 2 are arranged face-to-face in such a way that the output aperture of the press device and the input aperture of the waste container are face-to-face. Coupling means are arranged in the frame structure arrangement according to the invention, by the aid of which coupling means a detachable waste container 3 can be fixed into connection with a pneumatic wastes conveying system, more particularly with the press 2 of it, and can be detached from being in connection with it.

In the embodiment according to the figures the body structure system is therefore applied in connection with a separating device 1, a press device 2 and a waste container 3 applicable to a pneumatic waste-conveying system.

The waste material coming with the transporting air along the waste conveying piping of the pneumatic waste conveying system comes to the separating device, in which the waste material is separated from the transporting air. The waste material leaving the separating device 1 is displaced with the press 2 and compacted into the container space of the waste container 3.

Although, insofar as standards are concerned, the ISO standard is referred to in the preceding, the construction system according to the invention can also be applied in connection with other standards in use for freight containers or with future standards relating to containers.

The invention thus relates to a device component of a pneumatic waste conveying system, which device component comprises a frame structure arrangement. A device component 10, 20, 30, such as a separating device, material container, press device or pump device unit, in the frame structure arrangement is arranged in a supported manner at least partly inside a support body framework 11, 31, which support body framework 11, 31 is configured to function as a freight transport container, and that the support body framework is configured to function as a support body for a device component at the installation site.

According to one embodiment a device component 10, 30 is arranged with bracing parts 122, 123; 321, 322, 323, 324, 325 in a supported manner inside a support body framework 11, 31,

According to one embodiment the support body framework 11 and the device component 10 arranged inside it are in a different attitude in the transport attitude than when installed at the installation site.

According to one embodiment the support body framework 11, 31 is arranged to correspond to the dimensions of a standardized freight container, at least in respect of its length and width, in the transport attitude.

According to one embodiment lifting points 119, 120, 319, 320, e.g. for the fork of a forklift truck, are arranged on the support body framework 11, 31.

According to one embodiment the support body frameworks 11, 31 for different device components are configured to be joined together at the installation site, e.g. with joint means.

According to one embodiment corner castings 115, 116, 117, 118, 115′, 116′, 117′, 118′; 315, 316, 317, 318, 315′, 316′, 317′, 318′ are arranged on the corners of the support body framework 11, 31, which corner castings comprise fixing points for fixing the support body framework to a means of transport or to a second support body framework or to a freight container.

According to one embodiment the device component is a separating device 10 of a pneumatic waste conveying system, in which separating device the material to be transported is separated from the transporting air.

According to one embodiment the device component is a waste container 30 of a pneumatic waste conveying system.

According to one embodiment the device component is a pumping station of a pneumatic waste conveying system.

According to one embodiment the device component is a press device.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Device component of a pneumatic waste conveying system, which device component comprises a frame structure arrangement, wherein the frame structure arrangement a device component, such as a separating device, material container, press device or pump device unit, is arranged in a supported manner at least partly inside a support body framework, which support body framework (11, 31) is configured to function as a freight transport container, and in that the support body framework is configured to function as a support body for the device component at the installation site.

2. Device component according to claim 1, wherein a device component is arranged with bracing parts in a supported manner inside a support body framework.

3. Device component according to claim 1, wherein the support body framework and the device component arranged inside it are in a different attitude in the transport attitude than when installed at the installation site.

4. Device component according to claim 1, wherein the support body framework is arranged to correspond to the dimensions of a standardized freight container, at least in respect of its length and width, in the transport attitude.

5. Device component according to claim 1, wherein lifting points, e.g. for the fork of a forklift truck, are arranged on the support body framework.

6. Device component according to claim 1, wherein the support body frameworks for different device components are configured to be joined together at the installation site, e.g. with joint means.

7. Device component according to claim 1, wherein corner castings are arranged on the corners of the support body framework, which corner castings comprise fixing points for fixing the support body framework to a means of transport or to a second support body framework or to a freight container.

8. Device component according to claim 1, wherein the device component is a separating device of a pneumatic waste conveying system, in which separating device the material to be transported is separated from the transporting air.

9. Device component according to claim 1, wherein the device component is a waste container of a pneumatic waste conveying system.

10. Device component according to claim 1, wherein the device component is a pumping station of a pneumatic waste conveying system.

11. Device component according to claim 1, wherein the device component is a press device.

12. Device component according to claim 2, wherein the support body framework and the device component arranged inside it are in a different attitude in the transport attitude than when installed at the installation site.

13. Device component according to claim 2, wherein the support body framework is arranged to correspond to the dimensions of a standardized freight container, at least in respect of its length and width, in the transport attitude.

14. Device component according to claim 3, wherein the support body framework is arranged to correspond to the dimensions of a standardized freight container, at least in respect of its length and width, in the transport attitude.

15. Device component according to claim 2, wherein lifting points, e.g. for the fork of a forklift truck, are arranged on the support body framework.

16. Device component according to claim 3, wherein lifting points, e.g. for the fork of a forklift truck, are arranged on the support body framework.

17. Device component according to claim 4, wherein lifting points, e.g. for the fork of a forklift truck, are arranged on the support body framework.

18. Device component according to claim 2, wherein the support body frameworks for different device components are configured to be joined together at the installation site, e.g. with joint means.

19. Device component according to claim 3, wherein the support body frameworks for different device components are configured to be joined together at the installation site, e.g. with joint means.

20. Device component according to claim 4, wherein the support body frameworks for different device components are configured to be joined together at the installation site, e.g. with joint means.
